(19) United States
(12) Patent Application Publication
(10) Pub. No.: US 2023/0206889 A1
(43) Pub. Date: Jun. 29, 2023

(54) AUTOMATIC PERFORMANCE APPARATUS, AUTOMATIC PERFORMANCE METHOD, AND NON-TRANSITORY COMPUTER READABLE MEDIUM

(71) Applicant: Roland Corporation, Shizuoka (JP)

(72) Inventor: Kenichiro NISHI, Shizuoka (JP)

(73) Assignee: Roland Corporation, Shizuoka (JP)

(21) Appl. No.: 17/987,870

(22) Filed: Nov. 16, 2022

(30) Foreign Application Priority Data
Dec. 28, 2021 (JP) 2021-214552

(51) Int. Cl. G10H 1/00

(52) U.S. Cl. CPC G10H 1/0025; G10H 2210/111; G10H 2210/375; G10H 2210/571

(57) ABSTRACT

The disclosure provides an automatic performance apparatus, an automatic performance method, and a non-transitory computer readable medium. Notes to be sounded are stored in chronological order for each beat position which is a sound generation timing in a performance pattern. A probability of generating sound at the beat position is stored for each beat position in a sound generation probability pattern. According to the probability stored in the sound generation probability pattern, it is determined whether to generate sound or not for each beat position of the performance pattern.

### CROSS-REFERENCE TO RELATED APPLICATION

This application claims the priority benefit of Japan application serial no. 2021-214552, filed on Dec. 28, 2021. The entirety of the above-mentioned patent application is hereby incorporated by reference herein and made a part of this specification.

### BACKGROUND

### Technical Field

The disclosure relates to an automatic performance apparatus, an automatic performance method, and a non-transitory computer readable medium.

### Related Art

Patent Document 1 (Japanese Patent Application Laid-Open No. 2012-234167) discloses an apparatus for searching for automatic accompaniment data. In this apparatus, when a user presses a key on a keyboard of a rhythm input device 10, trigger data indicating that the key has been pressed, that is, a performance operation has been performed, and velocity data indicating an intensity of press of the key, that is, an intensity of the performance operation, are inputted to an information processing device 20 as an input rhythm pattern which is in units of one bar.

The information processing device 20 has a database including a plurality of automatic accompaniment data. Each automatic accompaniment data includes a plurality of parts, each having a unique rhythm pattern. When an input rhythm pattern has been inputted through the rhythm input device 10, the information processing device 20 searches for automatic accompaniment data having a rhythm pattern identical or similar to the input rhythm pattern and displays a list of the names and the like of the retrieved automatic accompaniment data. The information processing device 20 outputs a sound based on automatic accompaniment data selected by the user from the displayed list.

However, the rhythm pattern included in the automatic accompaniment data used for output is fixed. Therefore, once automatic accompaniment data is selected, the same rhythm pattern continues to be outputted repeatedly, so the sound based on the outputted automatic accompaniment data becomes monotonous.

### SUMMARY

An automatic performance apparatus of an embodiment of the disclosure automatically performs a performance pattern in which sound generation timings of notes to be sounded are set, and includes a sound generation probability pattern acquisition part and an automatic performance part. The sound generation probability pattern acquisition part acquires a sound generation probability pattern in which a probability of sounding a note is set for each sound generation timing of the performance pattern. The automatic performance part performs an automatic performance by determining whether to sound the note for each sound generation timing of the performance pattern based on the probability of each sound generation timing set in the sound generation probability pattern acquired by the sound generation probability pattern acquisition part.

An automatic performance method of an embodiment of the disclosure includes steps below. In a sound generation probability pattern acquisition step, a sound generation probability pattern is acquired in which a probability of sounding a note is set for each sound generation timing of a performance pattern in which sound generation timings of notes to be sounded are set. In an automatic performance step, an automatic performance is performed by determining whether to sound the note for each sound generation timing of the performance pattern based on the probability of each sound generation timing set in the sound generation probability pattern acquired in the sound generation probability pattern acquisition step.

An automatic performance program of the disclosure is a program causing a computer to perform an automatic performance, and causes the computer to execute steps below. In a sound generation probability pattern acquisition step, a sound generation probability pattern is acquired in which a probability of sounding a note is set for each sound generation timing of a performance pattern in which sound generation timings of notes to be sounded are set. In an automatic performance step, an automatic performance is performed by determining whether to sound the note for each sound generation timing of the performance pattern based on the probability of each sound generation timing set in the sound generation probability pattern acquired in the sound generation probability pattern acquisition step.

### BRIEF DESCRIPTION OF THE DRAWINGS

FIG. 1 is an external view of a synthesizer according to an embodiment.

FIG. 2A is a view schematically showing a performance pattern. FIG. 2B is a view schematically showing a sound generation probability pattern. FIG. 2C is a view schematically showing a performance pattern obtained by applying the sound generation probability pattern of FIG. 2B to the performance pattern of FIG. 2A. FIG. 2D is a view schematically showing a variable sound generation probability pattern in the case where an operation mode is a mode 1. FIG. 2E is a view schematically showing a sound generation probability pattern in the case where the operation mode is a mode 2.

FIG. 3A is a view schematically showing a performance pattern including chords. FIG. 3B is a view schematically showing a sound generation probability pattern applied to the performance pattern of FIG. 3A. FIG. 3C and FIG. 3D are views each schematically showing a performance pattern obtained by applying the sound generation probability pattern of FIG. 3B to the performance pattern of FIG. 3A.

FIG. 4 is a block diagram showing the electrical configuration of the synthesizer.

FIG. 5A is a view illustrating beat positions. FIG. 5B is a view schematically showing an input pattern table.

FIG. 6A is a table illustrating states of input patterns. FIG. 6B is a view schematically showing a state pattern table.

FIG. 7A is a view schematically showing a variable sound generation probability table. FIG. 7B is a view schematically showing a sound generation probability comparison table. FIG. 7C is a view schematically showing a fixed sound generation probability table.

FIG. 8A is a view illustrating a transition route. FIG. 8B is a view schematically showing an inter-transition route likelihood table.

FIG. 9A is a view schematically showing a pitch likelihood table. FIG. 9B is a view schematically showing a synchronization likelihood table.

FIG. 10A is a view schematically showing an IOI likelihood table. FIG. 10B is a view schematically showing a likelihood table. FIG. 10C is a view schematically showing a previous likelihood table.

FIG. 11 is a flowchart of a main process.

FIG. 12 is a flowchart of a maximum likelihood pattern search process.

FIG. 13A is a flowchart of a likelihood calculation process. FIG. 13B is a flowchart of an inter-state likelihood combination process.

FIG. 14 is a flowchart of an inter-transition likelihood combination process.

### DESCRIPTION OF THE EMBODIMENTS

Embodiments of the disclosure provide an automatic performance apparatus and an automatic performance program capable of realizing a highly expressive performance in which monotony is suppressed even when a performance pattern is automatically performed.

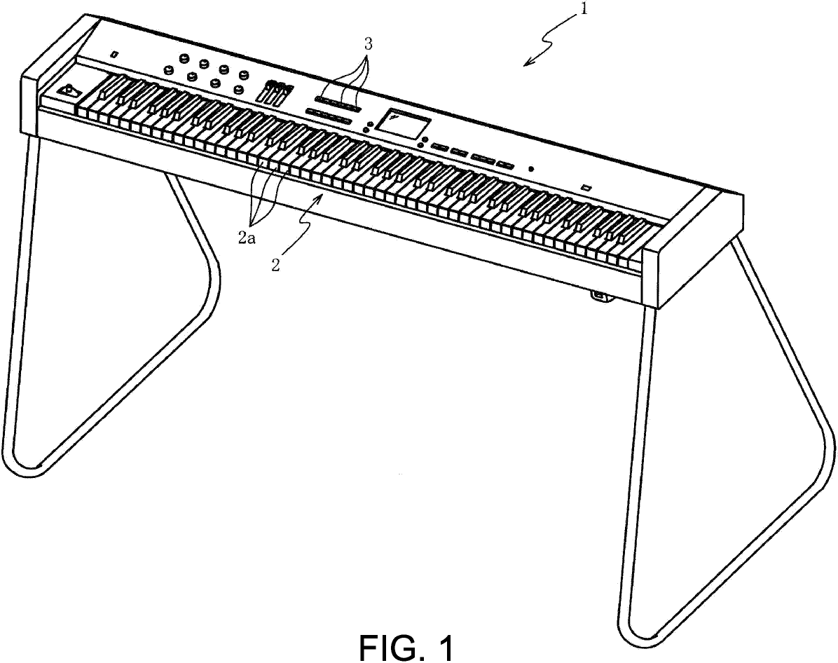

Hereinafter, exemplary embodiments will be described with reference to the accompanying drawings. FIG. 1 is an external view of a synthesizer 1 according to an embodiment. The synthesizer 1 is an electronic musical instrument (automatic performance apparatus) that mixes and outputs (emits) a musical sound generated by a performance operation of a performer (user), a predetermined accompaniment sound, etc. The synthesizer 1 may apply an effect such as reverb, chorus, delay, etc. by performing arithmetic processing on waveform data obtained by mixing a musical sound generated by the performer’s performance, an accompaniment sound, etc.

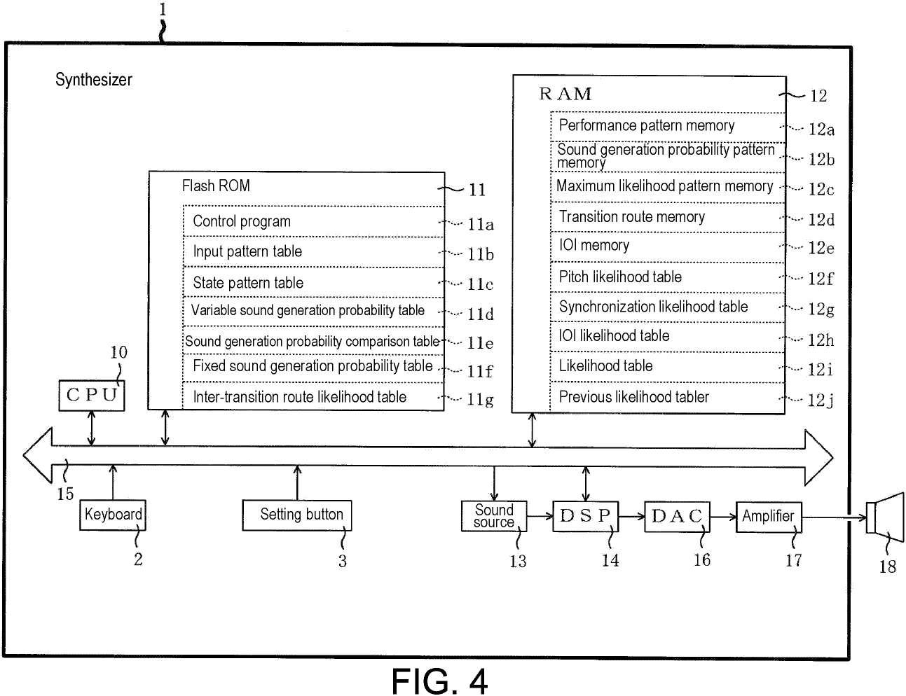

As shown in FIG. 1, the synthesizer 1 mainly includes a keyboard 2 and setting buttons 3 for inputting various settings from the performer. A plurality of keys 2a are provided on the keyboard 2, serving as an input device for acquiring performance information generated by the performer’s performance. Performance information according to the musical instrument digital interface (MIDI) standard corresponding to a key press/release operation of a key 2a performed by the performer is outputted to a CPU 10 (see FIG. 4).

The synthesizer 1 of this embodiment stores a performance pattern Pa in which a note to be sounded is set at each sound generation timing, and an automatic performance is performed by performing a performance based on the performance pattern Pa. At this time, whether to sound the note at each sound generation timing of the performance pattern is switched according to a sound generation probability pattern Pb in which a probability is set for each sound generation timing. Further, the probability set for each sound generation timing in the sound generation probability pattern Pb is determined according to performance information from the key 2a operated by the performer. Hereinafter, the automatic performance based on the performance pattern Pa will be simply referred to as an “automatic performance”.

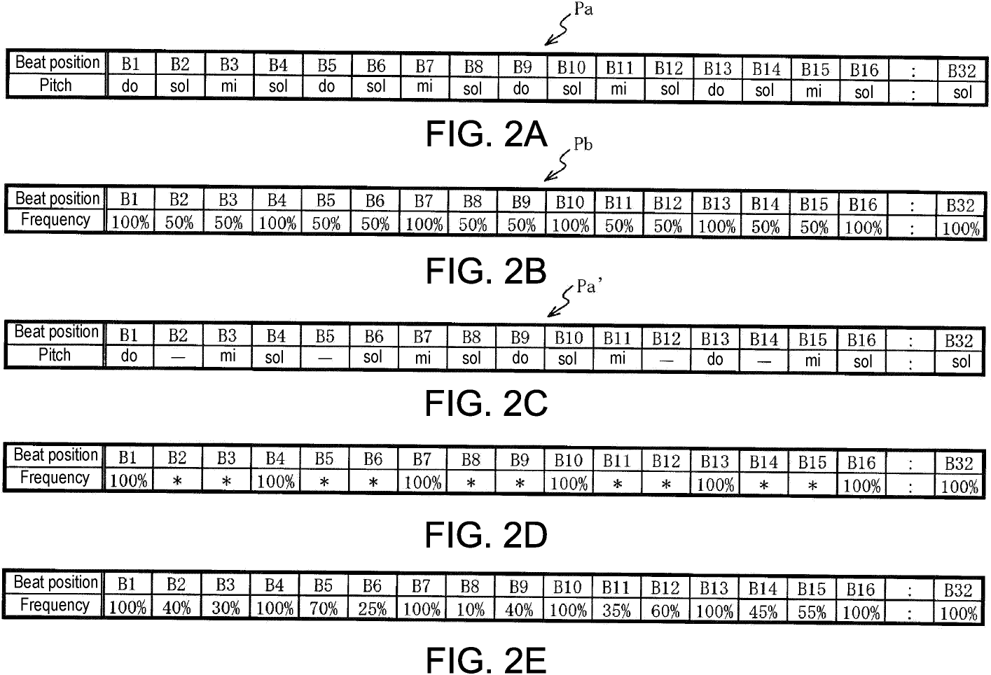

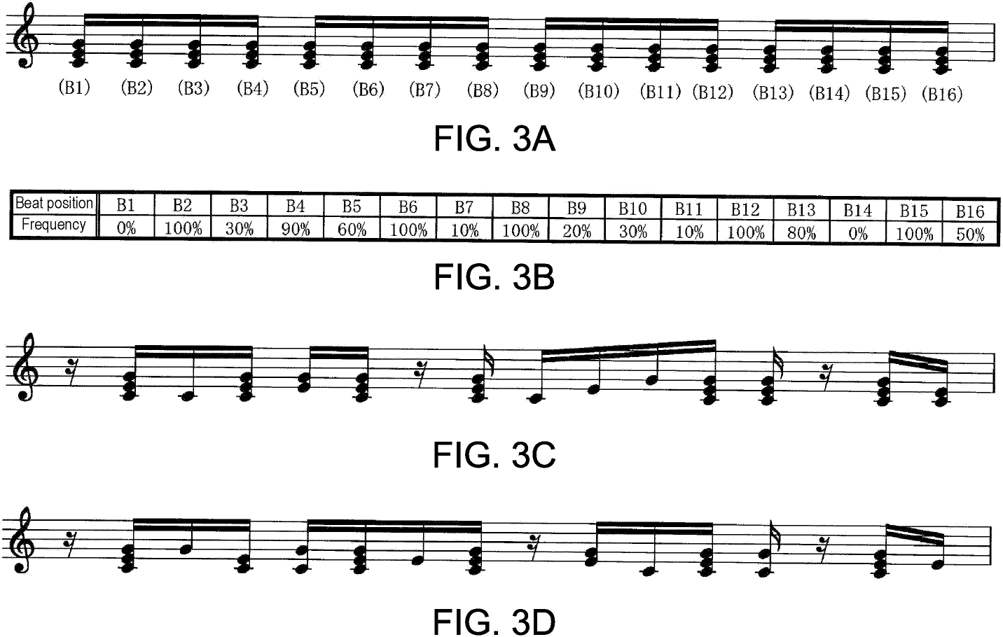

Next, the performance pattern Pa and the sound generation probability pattern Pb will be described with reference to FIG. 2A to FIG. 3D. FIG. 2A is a view schematically showing a performance pattern Pa, FIG. 2B is a view schematically showing a sound generation probability pattern Pb, and FIG. 2C is a view schematically showing a performance pattern Pa′ obtained by applying the sound generation probability pattern Pb of FIG. 2B to the performance pattern Pa of FIG. 2A.

As shown in FIG. 2A, a note to be sounded is stored in chronological order in the performance pattern Pa for each beat position, which is the sound generation timing. By playing notes corresponding to the sequence of beat positions stored in the performance pattern Pa, an automatic performance based on the performance pattern Pa may be performed.

Further, as shown in FIG. 2B, the sound generation probability pattern Pb stores, for each beat position, a probability (0 to 100%) of sounding the note of the beat position. Whether to generate sound or not is determined for each beat position according to the probability stored in the sound generation probability pattern Pb.

By applying the sound generation probability pattern of FIG. 2B to the performance pattern Pa of FIG. 2A, a performance pattern Pa′ to be actually used in automatic performance is created. Such a performance pattern Pa′ is shown in FIG. 2C.

In the performance pattern Pa′ of FIG. 2C, a “-” symbol indicating “not to generate sound” is respectively set at beat positions B2, B5, B12, and B14, which are beat positions at which sound is generated in FIG. 2A, and sound is not generated in the automatic performance at these beat positions. On the other hand, in the performance pattern Pa′ of FIG. 2C, since a probability greater than 0% is set in the sound generation probability pattern Pb at the beat positions B2, etc. determined as “not to generate sound”, there is a possibility that “to generate sound” may be determined in a next automatic performance.

In this manner, by determining whether to generate sound or not in the performance pattern Pa according to the probability set for each beat position in the sound generation probability pattern Pb, each time automatic performance is performed based on the performance pattern Pa, the beat positions at which sound is generated can be changed. Accordingly, even if automatic performance is repeatedly performed based on the same performance pattern Pa, the automatic performance is prevented from becoming monotonous, and an automatic performance rich in expressiveness can be realized.

In this embodiment, two modes, i.e., a mode 1 and a mode 2, are provided as the method (hereinafter referred to as an “operation mode”) for setting a probability of each beat position in the sound generation probability pattern Pb. In the mode 1 among the operation modes, in the sound generation probability pattern Pb, “100%” is set at predetermined beat positions at which sound is to be always generated, and a probability corresponding to an input pattern Pi which is maximum-likelihood-estimated based on input of performance information to the key 2a (to be described later) is set at the other beat positions. Hereinafter, such a sound generation probability pattern Pb will be referred to as a “variable sound generation probability pattern”.

FIG. 2D is a view schematically showing a variable sound generation probability pattern in the mode 1. As shown in FIG. 2D, in the variable sound generation probability pattern, 100% is set at beat positions at which sound is to be always generated, and a symbol “*” representing a so-called wild card to which any probability may be set is set at the other beat positions. A probability corresponding to the input pattern Pi which is maximum-likelihood-estimated based on input of performance information to the key 2a is respectively set at the beat positions set with “*” in the variable sound generation probability pattern.

For example, in FIG. 2D, since “*” is set at beat positions B2, B3, B5, B6, B8, B9, B11, B12, B14, and B15, in the case where the probability corresponding to the input pattern Pi which is maximum-likelihood-estimated based on input of performance information to the key 2a is “50%”, “50%” is set at each of these beat positions.

In this manner, in the case where the operation mode is the mode 1, a probability corresponding to the input pattern Pi which is maximum-likelihood-estimated based on input of performance information to the key 2a, i.e., a probability corresponding to the performance of the performer, is set in the sound generation probability pattern Pb. Accordingly, since it is possible to switch whether to generate sound or not in the performance pattern Pa according to the performance of the performer, an automatic performance matching the performance of the performer can be outputted. Further, since it is not necessary to set a probability at all beat positions in the sound generation probability pattern Pb, the sound generation probability pattern Pb can be easily created.

Further, in the variable sound generation probability pattern, “100%” is set in advance at beat positions at which sound is to be always generated. For example, by setting “100%” at musically meaningful beat positions such as a head of bar, it is possible to appropriately maintain the melody and rhythm of the automatic performance.

The variable sound generation probability pattern is not limited to setting “100%” in advance, but a probability of 100% or less such as “50%”, “75%”, etc. may also be set. Further, a probability corresponding to the input pattern Pi which is maximum-likelihood-estimated based on input of performance information to the key 2a is not necessarily set at all beat positions set with “*” in the variable sound generation probability pattern, but the probability may also be set at part of the beat positions set with “*” in the variable sound generation probability pattern.

Next, the case where the operation mode is the mode 2 will be described. In the mode 2, a plurality of sound generation probability patterns Pb (e.g., FIG. 2E) corresponding to the performance pattern Pa to be maximum-likelihood-estimated are stored in advance. Then, among the stored sound generation probability patterns Pb, a sound generation probability pattern Pb corresponding to the input pattern Pi which is maximum-likelihood-estimated based on input of performance information to the key 2a is acquired and used for automatic performance.

In this manner, in the case where the operation mode is the mode 2, among the pre-stored sound generation probability patterns Pb, the sound generation probability pattern Pb corresponding to the input pattern Pi which is maximum-likelihood-estimated based on input of performance information to the key 2a is acquired. Accordingly, it is similarly possible to switch whether sound is generated or not in the performance pattern Pa according to the performance of the performer, and it is possible to output an automatic performance matching the performance of the performer.

Further, the probability at each beat position in the sound generation probability pattern Pb is stored in advance. By setting the probability set at each beat position in the sound generation probability pattern Pb in detail according to the corresponding input pattern Pi (of maximum likelihood estimation), the sound generation probability pattern Pb can be made to correspond to the performer’s intention or preference.

Herein, in the performance pattern Pa of this embodiment, one beat position may not only be set with one note, but a plurality of notes may also be set at one beat position as a chord. Application of the sound generation probability pattern Pb in the case of setting chords will be described with reference to FIG. 3A to FIG. 3D.

FIG. 3A is a view schematically showing a performance pattern Pa including chords, FIG. 3B is a view schematically showing a sound generation probability pattern Pb applied to the performance pattern Pa of FIG. 3A, and FIG. 3C and FIG. 3D are views schematically showing a performance pattern Pa′ obtained by applying the sound generation probability pattern Pb of FIG. 3B to the performance pattern Pa of FIG. 3A.

When applying the sound generation probability pattern Pb shown in FIG. 3B to the performance pattern Pa including chords shown in FIG. 3A, the probability in the sound generation probability pattern Pb at the corresponding beat position is applied to each note composing the chord. For example, at the beat position B3 of the performance pattern Pa in FIG. 3A, a three-sound chord composed of “do-mi-sol” is set. A “30%” probability at the beat position B3 in the sound generation probability pattern Pb of FIG. 3B is applied to each of these three sounds, and whether to generate sound or not is determined independently for these three sounds.

In this manner, FIG. 3C and FIG. 3D show a performance pattern Pa′ obtained by applying the sound generation probability pattern Pb of FIG. 3B to the performance pattern Pa of FIG. 3A. While a three-sound chord composed of “do-mi-sol” is continuously set in the performance pattern Pa in FIG. 3A, in the performance pattern Pa′ in FIG. 3C and FIG. 3D, whether the three sounds composed of “do-mi-sol” are generated or not is set according to the probability of the sound generation probability pattern Pb at each beat position.

Accordingly, since it is possible to vary the sounds that compose the chord, it is possible to prevent the automatic performance based on the performance pattern Pa from becoming monotonous, and it is possible to make the chord rich in variety. Further, since whether to generate sound or not is determined for each note composing the chord, it is possible to suppress occurrence of a situation in which all the notes that compose a chord are not sounded. Accordingly, it is possible to suppress a sense of incongruity with respect to sound generation of chords by automatic performance.

The probability in the sound generation probability pattern Pb at the corresponding beat position is not necessarily applied to all the notes that compose the chord, but, for example, the probability in the sound generation probability pattern Pb may also be applied to a specific note (e.g., the note with the highest pitch or the note with the lowest pitch) among the notes that compose the chord. Alternatively, in the sound generation probability pattern Pb, a probability may be set for each note composing a chord, or corresponding probabilities may be applied to respective notes that compose a chord.

Next, an electrical configuration of the synthesizer 1 will be described with reference to FIG. 4 to FIG. 8B. FIG. 4 is a block diagram showing the electrical configuration of the synthesizer 1. The synthesizer 1 includes a CPU 10, a flash ROM 11, a RAM 12, a keyboard 2, the setting buttons 3 described above, a sound source 13, and a digital signal processor 14 (hereinafter referred to as a “DSP 14”), which are connected via a bus line 15. A digital-to-analog converter (DAC) 16 is connected to the DSP 14, an amplifier 17 is connected to the DAC 16, and a speaker 18 is connected to the amplifier 17.

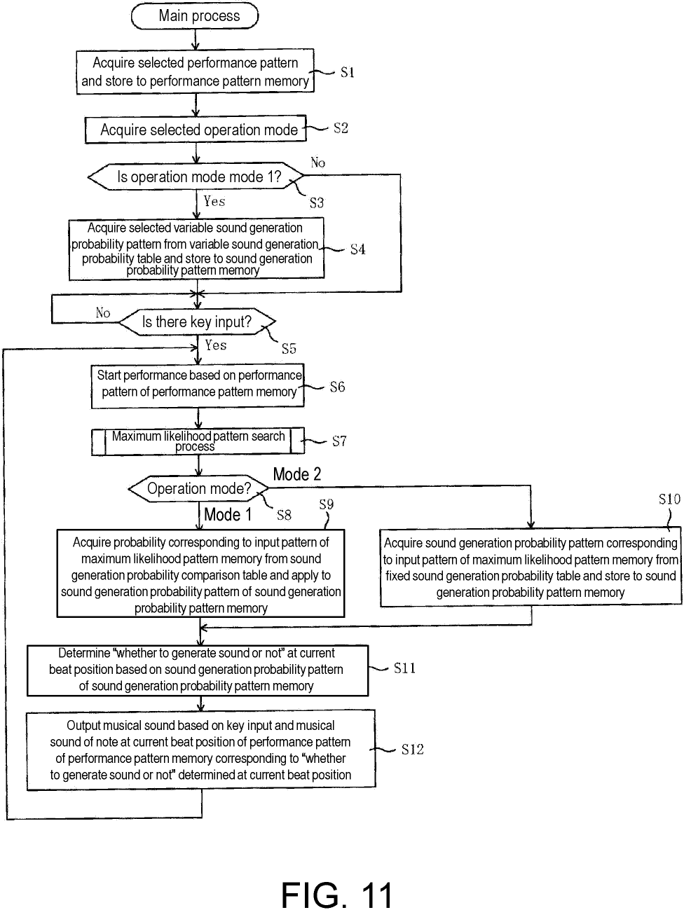

The CPU 10 is an arithmetic device that controls each part connected via the bus line 15. The flash ROM 11 is a rewritable nonvolatile memory provided with a control program 11a, an input pattern table 11b, a state pattern table 11c, a variable sound generation probability table 11d, a sound generation probability comparison table 11e, a fixed sound generation probability table 11f, and an inter-transition route likelihood table 11g. A main process of FIG. 11 is executed by the CPU 10 executing the control program 11a.

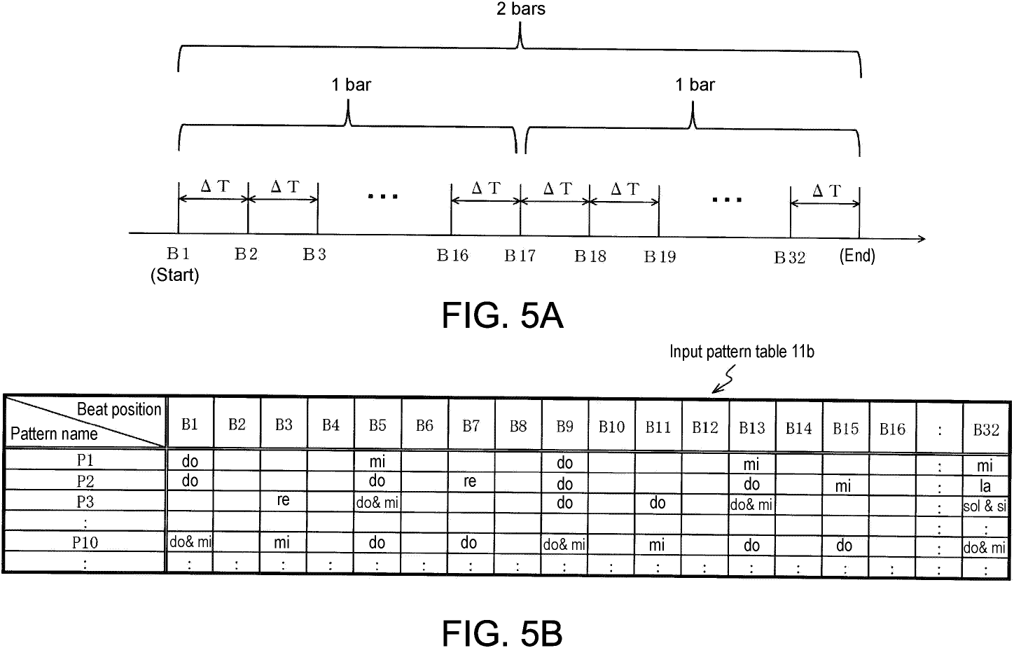

The input pattern table 11b is a data table storing performance information and input patterns Pi which match the performance information. Herein, beat positions in the input pattern Pi and the input pattern table 11b will be described with reference to FIG. 5A and FIG. 5B.

FIG. 5A is a view illustrating the beat positions. In this embodiment, as shown in FIG. 5A, a performance duration of each output pattern Pi has a length of two bars in common time. Beat positions B1 to B32 obtained by dividing the length of two bars equally by the length of a sixteenth note (i.e., by dividing it into 32 equal parts) are each regarded as one temporal position unit. Herein, a time ΔT in FIG. 5A represents the length of a sixteenth note. The input pattern table 11b stores an input pattern Pi and the arrangement of pitch of each beat position corresponding to the input pattern Pi in association with each other. Such an input pattern table 11b is shown in FIG. 5B.

FIG. 5B is a view schematically showing the input pattern table 11b. As shown in FIG. 5B, pitches (do, re, mi, ...) for the beat positions B1 to B32 are respectively set in the input pattern Pi. Further, in the input pattern Pi, for any of the beat positions B1 to B32, not only may a single pitch be set, but a combination of two or more pitches may also be designated. In this embodiment, to designate that two or more pitches are inputted at the same time, the corresponding pitch names are linked by “&” at the beat position B1 to B32. For example, at the beat position B5 of the input pattern P3 in FIG. 5B, pitches “do & mi” are designated, which designates that “do” and “mi” are inputted at the same time.

In the input pattern Pi, pitches are defined for beat positions B1 to B32 for which the input of performance information is designated, while no pitches are defined for beat positions B1 to B32 for which the input of performance information is not designated. Further, in this embodiment, in the input pattern table 11b, input patterns P1, P2, P3, ... are set in a descending order of a time interval between beat positions in the input pattern Pi for which performance information is set.

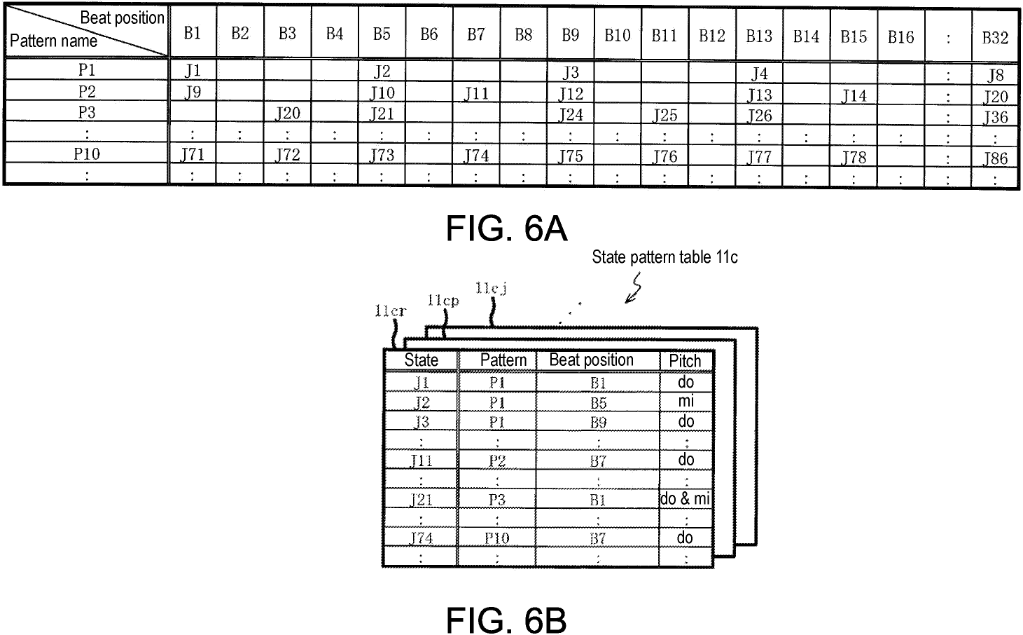

In this embodiment, to manage combinations of the beat positions B1 to B32 and the pitches, a combination of these is defined as a “state”. Such states with respect to the input patterns Pi will be described with reference to FIG. 6A.

FIG. 6A is a table illustrating states of input patterns. As shown in FIG. 6A, states J1, J2, ... are defined for the beat positions B1 to B32 for which pitches are designated, in a sequence from the beat position B1 in the input pattern P1. Specifically, the beat position B1 of the input pattern P1 is defined as a state J1, the beat position B5 of the input pattern P1 is defined as a state J2, ... , the beat position B32 of the input pattern P1 is defined as a state J8, and the beat position B1 of the input pattern P2 is defined as a state J9, subsequent to the state J8. Hereinafter, the states J1, J2, ... will each be simply referred to as a “state Jn” unless particularly distinguished.

In the state pattern table 11c, a name of a corresponding input pattern Pi, a beat position B1 to B32, and a pitch are stored for each state Jn. Such a state pattern table 11c will be described below with reference to FIG. 6B.

FIG. 6B is a view schematically showing the state pattern table 11c. The state pattern table 11c is a data table in which a name of a corresponding input pattern Pi, a beat position B1 to B32, and a pitch are stored for each state Jn for each music genre (e.g., rock, pop, and jazz) that may be designated in the synthesizer 1. In this embodiment, the state pattern table 11c stores input patterns for each music genre, and input patterns Pi corresponding to a selected music genre are referred to from the state pattern table 11c.

Specifically, input patterns Pi corresponding to the music genre “rock” are defined as a state pattern table 11cr, input patterns Pi corresponding to the music genre “pop” are defined as a state pattern table 11cp, input patterns Pi corresponding to the music genre “jazz” are defined as a state pattern table 11cj, and input patterns Pi are similarly stored for other music genres. Hereinafter, the state pattern tables 11cp, 11cr, 11cj, ... in the state pattern table 11c will each be referred to as a “state pattern table 11cx” unless particularly distinguished.

When performance information is inputted from the key 2a, a “likely” state Jn is estimated based on a beat position and a pitch of the performance information and a beat position and a pitch of a state pattern table 11cx corresponding to the selected music genre, and an input pattern Pi is acquired from the state Jn.

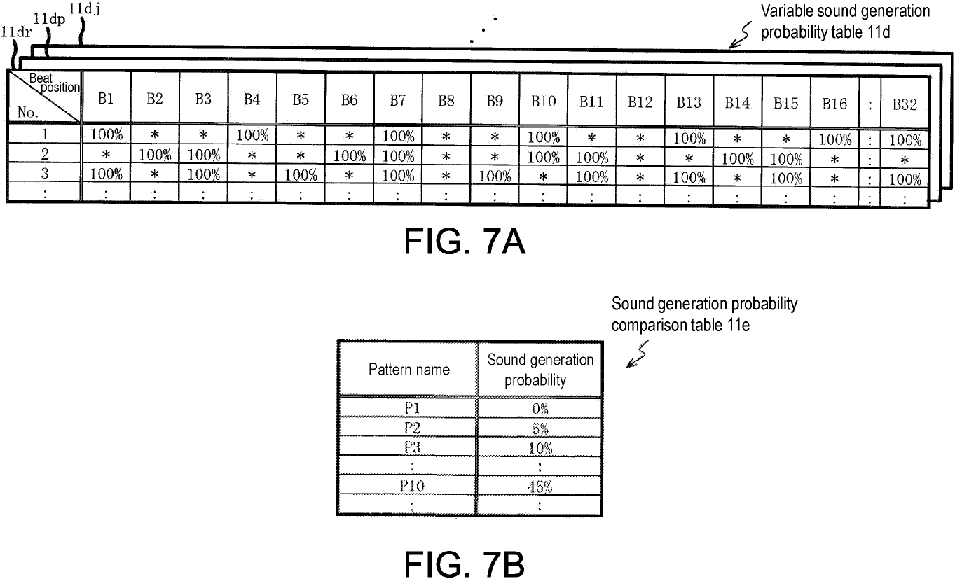

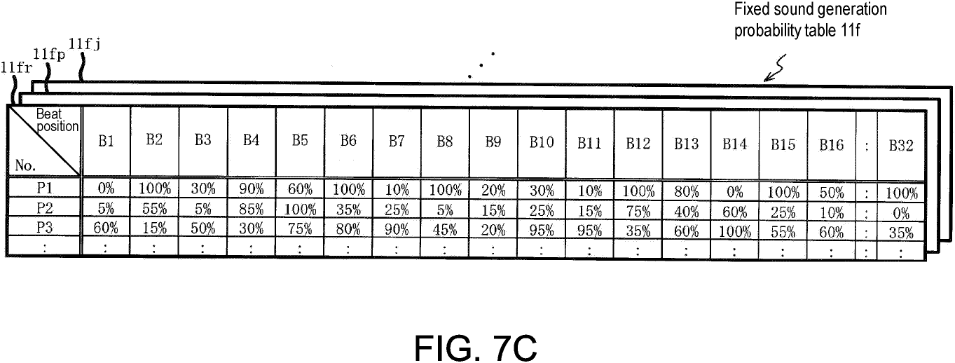

Referring back to FIG. 4, the variable sound generation probability table 11d is a data table that stores variable sound generation probability patterns in the case where the operation mode is the mode 1. The sound generation probability comparison table 11e is a data table that stores probabilities corresponding to maximum-likelihood-estimated input patterns Pi. The fixed sound generation probability table 11f is a data table that stores sound generation probability patterns Pb in the case where the operation mode is the mode 2 described above. The variable sound generation probability table 11d, the sound generation probability comparison table 11e, and the fixed sound generation probability table 11f will be described with reference to FIG. 7A to FIG. 7C.

FIG. 7A is a view schematically showing the variable sound generation probability table 11d. As shown in FIG. 7A, the variable sound generation probability table 11d stores a plurality of variable sound generation probability patterns. In the case where the operation mode is the mode 1, one variable sound generation probability pattern is selected by the performer from the variable sound generation probability table 11d, and the selected variable sound generation probability pattern is used for automatic performance.

In this embodiment, the variable sound generation probability table 11d stores variable sound generation probability patterns for each music genre, and the variable sound generation probability patterns corresponding to a selected music genre are referred to from the variable sound generation probability table 11d. Specifically, variable sound generation probability patterns corresponding to music genres “rock”, “pop”, and “jazz” are respectively defined as variable sound generation probability tables 11dr, 11dp, and 11dj, and variable sound generation probability patterns are similarly stored for other music genres. Hereinafter, the variable sound generation probability tables 11dr, 11dp, and 11dj will each be referred to as a “variable sound generation probability table 11dx” unless particularly distinguished.

FIG. 7B is a view schematically showing the sound generation probability comparison table 11e. As shown in FIG. 7B, the sound generation probability comparison table 11e stores a corresponding probability for each maximum-likelihood-estimated input pattern Pi. By setting a probability acquired according to the input pattern Pi from the sound generation probability comparison table 11e to the variable sound generation probability pattern acquired from the variable sound generation probability table 11d of FIG. 7A, a sound generation probability pattern Pb used for automatic performance is created.

In the sound generation probability comparison table 11e, increasing probability values are stored in an arrangement sequence similar to that of the input pattern table 11b described above, i.e., in a sequence of the input patterns Pi arranged in a descending order of the time interval between the beat positions for which performance information is set. Accordingly, the longer the interval of the performance information inputted by the performer, the smaller the probability acquired; and the shorter the interval of the performance information inputted by the performer, the greater the probability acquired.

Therefore, as the interval of performance information inputted by the performer increases, the probability that sound is generated in the automatically performed performance pattern Pa decreases, and the beat positions at which sound is generated in the automatically performed performance pattern Pa become sparse. Accordingly, it is possible to perform an automatic performance based on a performance pattern Pa matching a performance of a performer with a long interval of performance information inputted by the performer, i.e., at a slow tempo.

On the other hand, as the interval of performance information inputted by the performer decreases, the probability that sound is generated in the automatically performed performance pattern Pa increases, and the beat positions at which sound is generated in the automatically performed performance pattern Pa become frequent. Accordingly, it is possible to perform an automatic performance based on a performance pattern Pa matching a performance of a performer with a short interval of performance information inputted by the performer, i.e., at an up-tempo.

The sound generation probability comparison table 11e is not limited to storing increasing probability values in a sequence of the input patterns Pi arranged in a descending order of the time interval between beat positions for which performance information is set, but, for example, the sound generation probability comparison table 11e may also store decreasing probability values in a sequence of the input patterns Pi arranged in a descending order of the time interval between beat positions for which performance information is set, or the sound generation probability comparison table 11e may also store random probability values unrelated to the corresponding input patterns Pi.

FIG. 7C is a view schematically showing the fixed sound generation probability table 11f. As shown in FIG. 7C, the fixed sound generation probability table 11f stores sound generation probability patterns Pb corresponding to the input patterns Pi. In the case where the operation mode is the mode 2, the sound generation probability pattern Pb corresponding to the maximum-likelihood-estimated input pattern Pi is acquired from the fixed sound generation probability table 11f and used for automatic performance.

In this embodiment, sound generation probability patterns Pb of each music genre are stored in the fixed sound generation probability table 11f, and the sound generation probability patterns Pb corresponding to a selected music genre are referred to from the fixed sound generation probability table 11f. Specifically, the sound generation probability patterns Pb corresponding to music genres “rock”, “pop”, and “jazz” are respectively defined as fixed sound generation probability tables 11fr, 11fp, and 11fj, and sound generation probability patterns Pb are similarly stored for other music genres. Hereinafter, the fixed sound generation probability tables 11fr, 11fp, 11fj, ... will each be referred to as a “fixed sound generation probability table 11fx” unless particularly distinguished.

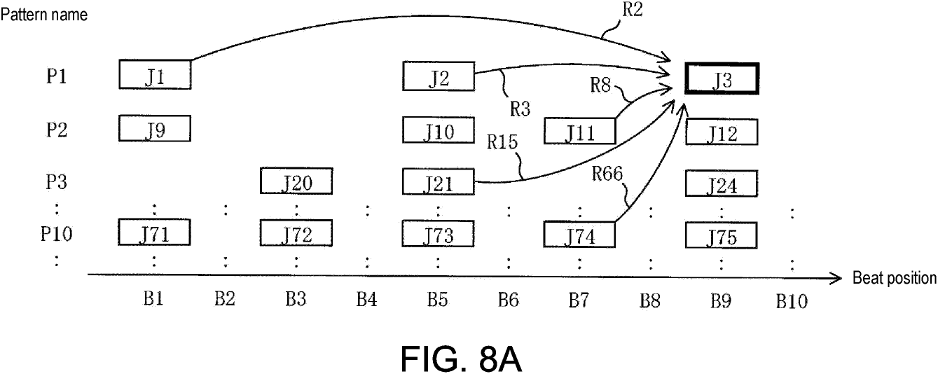

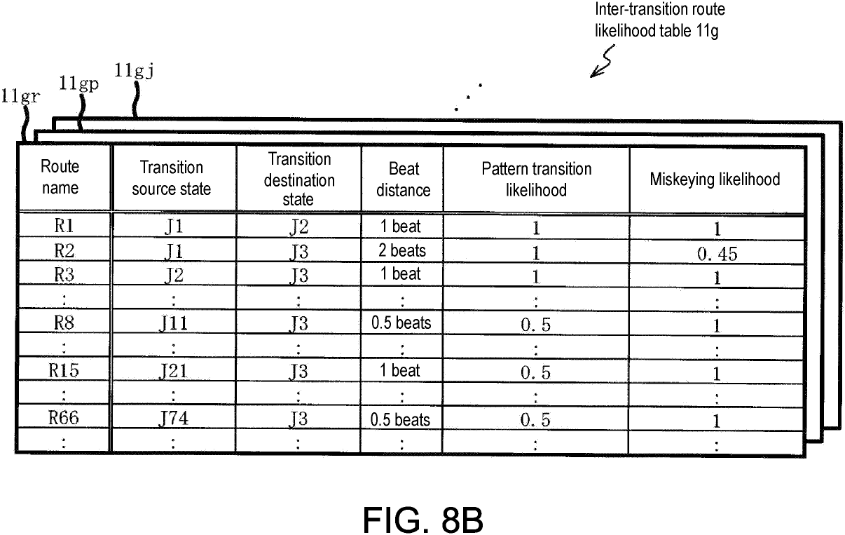

Referring back to FIG. 4, the inter-transition route likelihood table 11g is a data table that stores a transition route Rm between states Jn, a beat distance which is the distance between beat positions B1 to B32 of the transition route Rm, and a pattern transition likelihood and a miskeying likelihood for the transition route Rm. Herein, the transition route Rm and the inter-transition route likelihood table 11g will be described below with reference to FIG. 8A and FIG. 8B.

FIG. 8A is a view illustrating the transition route Rm, and FIG. 8B is a view schematically showing the inter-transition route likelihood table 11g. In FIG. 8A, the horizontal axis indicates the beat positions B1 to B32. As time elapses, the beat position progresses from the beat position B1 to the beat position B32, and the state Jn in each input pattern Pi also changes, as shown in FIG. 8A. In this embodiment, assumed routes between states Jn in transitions between the states Jn are preset. Hereinafter, the preset routes for transitions between the states Jn will be referred to as “transition routes R1, R2, R3, ... ,” and these will each be referred to as a “transition route Rm” unless particularly distinguished.

Transition routes to the state J3 are shown in FIG. 8A. Roughly two types of transition routes are set as the transition routes to the state J3, the first for transitions from states Jn of the same input pattern Pi (i.e., the input pattern P1) as the state J3, and the second for transitions from states Jn of an input pattern Pi different from the state J3.

A transition route R3 that transitions to the state J3 from a state J2 which is immediately prior to the state J3, and a transition route R2 which is a transition route from the state J1 which is two states prior to the state J3 are set as the transitions from states Jn in the same input pattern P1 as the state J3. That is, in this embodiment, no more than two transition routes, the first being a transition route that transitions from an immediately preceding state Jn, and the second being a transition route of “sound skipping” that transitions from a state which is two states ago, are set as transition routes to states Jn in the same pattern.

On the other hand, a transition route R8 that transitions from a state J11 of the input pattern P2 to the state J3, a transition route R15 that transitions from a state J21 of the input pattern 3 to the state J3, a transition route R66 that transitions from a state J74 of the input pattern P10 to the state J3, etc. may be set as the transition routes that transition from states Jn of patterns different from the state J3. That is, transition routes where a transition source state Jn of a different input pattern Pi is immediately prior to the beat position of a transition destination state Jn are set as transition routes to states Jn in different input patterns Pi.

A plurality of transition routes Rm to the state J3 are set in addition to the transition routes illustrated in FIG. 8A. Further, one or a plurality of transition routes Rm are also set for each state Jn in a manner similar to the state J3.

A “likely” state Jn is estimated based on the performance information of the key 2a, and an input pattern Pi corresponding to the state Jn is referred to. In this embodiment, a state Jn is estimated based on a likelihood which is a numerical value set for each state Jn and representing the “likelihood” between performance information of the key 2a and the state Jn. In this embodiment, the likelihood for the state Jn is calculated by combining the likelihood based on the state Jn itself, the likelihood based on the transition route Rm, or the likelihood based on the input pattern Pi.

The pattern transition likelihood and the miskeying likelihood stored in the inter-transition route likelihood table 11g are likelihoods based on the transition route Rm. Specifically, first, the pattern transition likelihood is a likelihood representing whether a transition source state Jn and a transition destination state Jn for the transition route Rm are in the same input pattern Pi. In this embodiment, “1” is set to the pattern transition likelihood in the case where the transition source and destination states Jn for the transition route Rm are in the same input pattern Pi, and “0.5” is set to the pattern transition likelihood in the case where the transition source and destination states Jn for the transition route Rm are in different input patterns Pi.

For example, in FIG. 8B, “1” is set to the pattern transition likelihood of the transition route R3 since the transition source of the transition route R3 is the state J2 of the input pattern P1 and the transition destination is the state J3 of the same input pattern P1. On the other hand, the transition route R8 is a transition route between different patterns since the transition source of the transition route R8 is the state J11 of the input pattern P2 and the transition destination is the state J3 of the input pattern P1. Therefore, “0.5” is set to the pattern transition likelihood of the transition route R8.

Further, the miskeying likelihood stored in the inter-transition route likelihood table 11g represents whether the transition source state Jn and the transition destination state Jn of the transition route Rm are in the same input pattern Pi and further the transition source state Jn is two states prior to the transition destination state Jn, that is, whether the transition route Rm having the transition source state Jn and the transition destination state Jn is due to sound skipping. In this embodiment, “0.45” is set to the miskeying likelihood of transition routes Rm having transition source and destination states Jn due to sound skipping and “1” is set to the miskeying likelihood of transition routes Rm other than those due to sound skipping.

For example, in FIG. 8B, “1” is set to the miskeying likelihood of the transition route R1 since the transition route R1 is a transition route between adjacent states J1 and J2 in the same input pattern P1 and is not a transition route due to sound skipping. On the other hand, “0.45” is set to the miskeying likelihood of the transition route R2 since the transition destination state J3 of the transition route R2 is two states subsequent to the transition source state J1.

Transition routes Rm due to sound skipping in which a transition source state Jn is two states prior to a transition destination state Jn in the same input pattern Pi are also set as described above. In actual performances, the probability of occurrence of a transition due to sound skipping is lower than the probability of occurrence of a normal transition. Therefore, by setting a smaller value to the miskeying likelihood of a transition route Rm due to sound skipping than to the miskeying likelihood of a normal transition route Rm which is not due to sound skipping, as in actual performances, it is possible to estimate a transition destination state Jn of a normal transition route Rm with priority over a transition destination state Jn of a transition route Rm due to sound skipping.

Further, as shown in FIG. 8B, in the inter-transition route likelihood table 11g, the transition source state Jn, the transition destination state Jn, the pattern transition likelihood, and the miskeying likelihood of the transition route Rm are stored for each transition route Rm in association with each other for each music genre designated in the synthesizer 1. In this embodiment, the inter-transition route likelihood table 11g also includes an inter-transition route likelihood table stored for each music genre. An inter-transition route likelihood table corresponding to the music genre “rock” is defined as an inter-transition route likelihood table 11gr, an inter-transition route likelihood table corresponding to the music genre “pop” is defined as an inter-transition route likelihood table 11gp, and an inter-transition route likelihood table corresponding to the music genre “jazz” is defined as an inter-transition route likelihood table 11gj. Inter-transition route likelihood tables are also defined for other music genres. Hereinafter, the inter-transition route likelihood tables 11gp, 11gr, 11gj, ... in the inter-transition route likelihood table 11g will each be referred to as an “inter-transition route likelihood table 11gx” unless particularly distinguished.

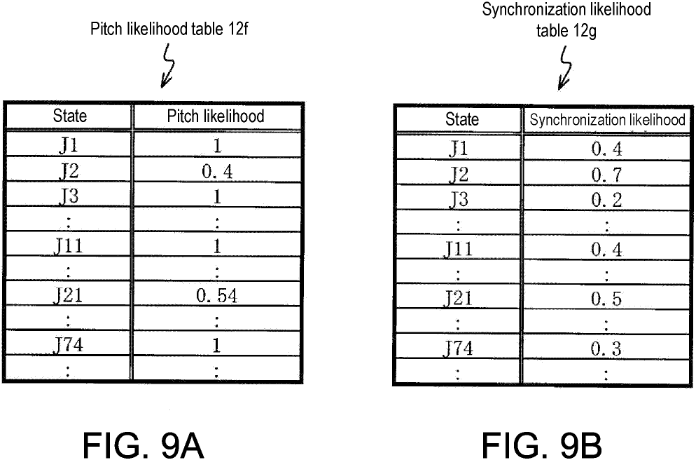

Referring back to FIG. 4, the RAM 12 is a memory for rewritably storing various work data, flags, etc. when the CPU 10 executes a program such as the control program 11a, and includes a performance pattern memory 12a in which performance patterns Pa used for automatic performance are stored, a sound generation probability pattern memory 12b in which sound generation probability patterns Pb used for automatic performance are stored, a maximum likelihood pattern memory 12c in which maximum-likelihood-estimated input patterns Pi are stored, a transition route memory 12d in which estimated transition routes Rm are stored, an IOI memory 12e in which a duration (i.e., a keying interval) from a timing of a previous pressing of the key 2a to a timing of a current pressing of the key 2a is stored, a pitch likelihood table 12f, a synchronization likelihood table 12g, an IOI likelihood table 12h, a likelihood table 12i, and a previous likelihood table 12j. The pitch likelihood table 12f will be described with reference to FIG. 9A.

FIG. 9A is a view schematically showing the pitch likelihood table 12f. The pitch likelihood table 12f is a data table that stores a pitch likelihood which is a likelihood representing a relationship between the pitch of the performance information of the key 2a and the pitch of the state Jn. In this embodiment, “1” is set as the pitch likelihood in the case where the pitch of the performance information of the key 2a and the pitch of the state Jn in the state pattern table 11cx (FIG. 6B) perfectly match, “0.54” is set in the case where the pitches partially match, and “0.4” is set in the case where the pitches do not match. In the case where the performance information of the key 2a has been inputted, the pitch likelihood is set for all states Jn.

FIG. 9A illustrates the pitch likelihood table 12f of the case where “do” has been inputted as the pitch of the performance information of the key 2a in the state pattern table 11cr of the music genre “rock” of FIG. 6B. Since the pitches of the state J1 and the state J74 in the state pattern table 11cr are “do,” “1” is set to the pitch likelihoods of the state J1 and the state J74 in the pitch likelihood table 12f. Further, since the pitch of the state J11 in the state pattern table 11cr is a wildcard pitch, it is assumed that the pitches perfectly match no matter what pitch is inputted. Therefore, “1” is also set to the pitch likelihood of the state J11 in the pitch likelihood table 12f.

Since the pitch of the state J2 in the state pattern table 11cr is “mi” and does not match the pitch “do” of the performance information of the key 2a, “0.4” is set for the state J2 in the pitch likelihood table 12f. Further, since the pitch of the state J21 in the state pattern table 11cr is “do & mi” and partially matches the pitch “do” of the performance information of the key 2a, “0.54” is set for the state J21 in the pitch likelihood table 12f. A state Jn whose pitch is closest to the pitch of the performance information of the key 2a can be estimated based on the pitch likelihood table 12f thus set.

Referring back to FIG. 4, the synchronization likelihood table 12g is a data table that stores a synchronization likelihood which is a likelihood representing the relationship between a timing in two bars at which the performance information of the key 2a has been inputted and the beat position B1 to B32 of the state Jn. The synchronization likelihood table 12g will be described below with reference to FIG. 9B.

FIG. 9B is a view schematically showing the synchronization likelihood table 12g. As shown in FIG. 9B, the synchronization likelihood table 12g stores a synchronization likelihood for each state Jn. In this embodiment, the synchronization likelihood is calculated according to a difference between the timing in two bars at which the performance information of the key 2a has been inputted and the beat position B1 to B32 of the state Jn stored in the state pattern table 11cx, based on a Gaussian distribution of Equation (2) which will be described later.

Specifically, a great value of synchronization likelihood is set for a state Jn of a beat position B1 to B32 having a small difference from the timing at which the performance information of the key 2a has been inputted. On the other hand, a small value of synchronization likelihood is set for a state Jn of a beat position B1 to B32 having a great difference from the timing at which the performance information of the key 2a has been inputted. By estimating a state Jn for the performance information of the key 2a based on the synchronization likelihood of the synchronization likelihood table 12g thus set, it is possible to estimate a state Jn of a beat position closest to the timing at which the performance information of the key 2a has been inputted.

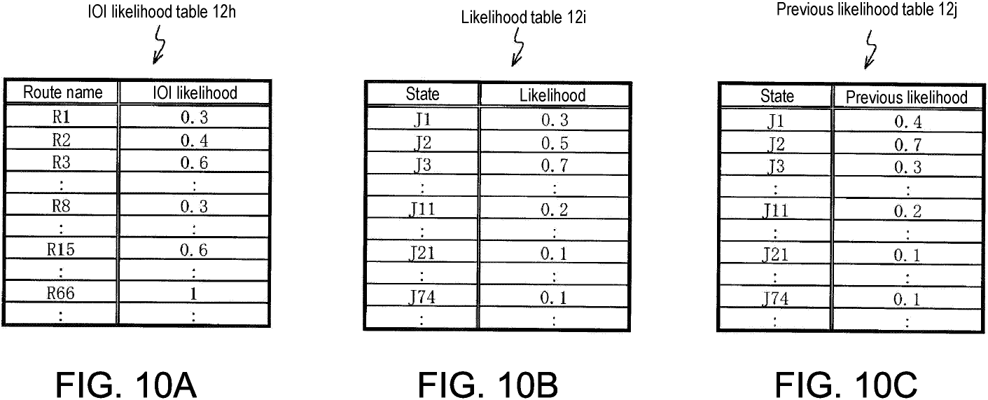

Referring back to FIG. 4, the IOI likelihood table 12h is a data table that stores an IOI likelihood representing the relationship between a keying interval stored in the IOI memory 12e and a beat distance of the transition route Rm stored in the inter-transition route likelihood table 11gx. The IOI likelihood table 12h will be described below with reference to FIG. 10A.

FIG. 10A is a view schematically showing the IOI likelihood table 12h. As shown in FIG. 10A, the IOI likelihood table 12h stores an IOI likelihood for each transition route Rm. In this embodiment, the IOI likelihood is calculated based on a keying interval stored in the IOI memory 12e and a beat distance of the transition route Rm stored in the inter-transition route likelihood table 11gx, according to Equation (1) which will be described later.

Specifically, a great value of IOI likelihood is set for a transition route Rm of a beat distance having a small difference from the keying interval stored in the IOI memory 12e. On the other hand, a small value of IOI likelihood is set for a transition route Rm of a beat distance having a great difference from the keying interval stored in the IOI memory 12e. By estimating a transition destination state Jn of a transition route Rm based on the IOI likelihood of the transition route Rm thus set, it is possible to estimate a state Jn that is based on a transition route Rm whose beat distance is closest to the keying interval stored in the IOI memory 12e.

Referring back to FIG. 4, the likelihood table 12i is a data table that stores a likelihood obtained by combining the pattern transition likelihood, the miskeying likelihood, the pitch likelihood, the synchronization likelihood, and the IOI likelihood described above for each state Jn, and the previous likelihood table 12j is a data table that stores a previous value of the likelihood of each state Jn stored in the likelihood table 12i. The likelihood table 12i and the previous likelihood table 12j will be described below with reference to FIG. 10B and FIG. 10C.

FIG. 10B is a view schematically showing the likelihood table 12i, and FIG. 10C is a view schematically showing the previous likelihood table 12j. As shown in FIG. 10B, the likelihood table 12i stores a result combining the pattern transition likelihood, the miskeying likelihood, the pitch likelihood, the synchronization likelihood, and the IOI likelihood for each state Jn. Among these likelihoods, in the pattern transition likelihood, the miskeying likelihood, and the IOI likelihood, likelihoods of the transition route Rm corresponding to the transition destination state Jn are combined. Further, the previous likelihood table 12j shown in FIG. 10C stores a likelihood of each state Jn that has been obtained through combination in previous processing and stored in the likelihood table 12i.

Referring back to FIG. 4, the sound source 13 is a device that outputs waveform data corresponding to performance information inputted from the CPU 10. The DSP 14 is an arithmetic device for arithmetically processing the waveform data inputted from the sound source 13. Through the DSP 14, an effect is applied to the waveform data inputted from the sound source 13.

The DAC 16 is a conversion device that converts the waveform data inputted from the DSP 14 into analog waveform data. The amplifier 17 is an amplifying device that amplifies the analog waveform data outputted from the DAC 16 with a predetermined gain, and the speaker 18 is an output device that emits (outputs) the analog waveform data amplified by the amplifier 17 as a musical sound.

Next, a main process executed by the CPU 10 will be described with reference to FIG. 11 to FIG. 14. FIG. 11 is a flowchart of the main process. The main process is executed when the synthesizer 1 is powered on.

In the main process, first, a performance pattern Pa selected by a performer via the setting button 3 (see FIG. 1) is acquired and stored to the performance pattern memory 12a (S1). The performance pattern Pa acquired in the process of S1 is selected from the performance patterns Pa stored in advance in the flash ROM 11, but an input pattern Pi stored in the input pattern table 11b (see FIG. 5B) may also be selected, and the selected input pattern Pi may be stored to the performance pattern memory 12a as the performance pattern Pa.

Along with acquisition of the performance pattern Pa selected by the performer, a music genre selected by the performer via the setting button 3 is also acquired. With respect to the state pattern table 11c, the variable sound generation probability table 11d, the fixed sound generation probability table 11f, or the inter-transition route likelihood table 11g stored for each music genre, a state pattern table 11cx, a variable sound generation probability table 11dx, a fixed sound generation probability table 11fx, or an inter-transition route likelihood table 11gx corresponding to the acquired music genre is referred to. Hereinafter, the “music genre acquired in the process of S1” will be referred to as the “corresponding music genre”.

After the process of S1, an operation mode selected by the performer via the setting button 3 is acquired (S2), and it is confirmed whether the acquired operation mode is a mode 1 (S3). In the process of S3, if the operation mode is the mode 1 (S3: Yes), a variable sound generation probability pattern selected by the performer via the setting button 3 is acquired from the variable sound generation probability table 11d and stored to the sound generation probability pattern memory 12b (S4). On the other hand, in the process of S3, if the operation mode is a mode 2 (S3: No), the process of S4 is skipped.

After the processes of S3 and S4, it is confirmed whether a key input, i.e., performance information from the key 2a, has been inputted (S5). In the process of S5, if the performance information from the key 2a has not been inputted (S5: No), the process of S5 is repeated.

On the other hand, in the process of S5, if the performance information from the key 2a has been inputted (S5: Yes), automatic performance is started based on the performance pattern Pa in the performance pattern memory 12a (S6). At this time, a tempo specified in the performance pattern Pa of the performance pattern memory 12a is acquired, and the performance pattern Pa is automatically performed based on the tempo. Hereinafter, this tempo will be referred to as the “tempo of the automatic performance”.

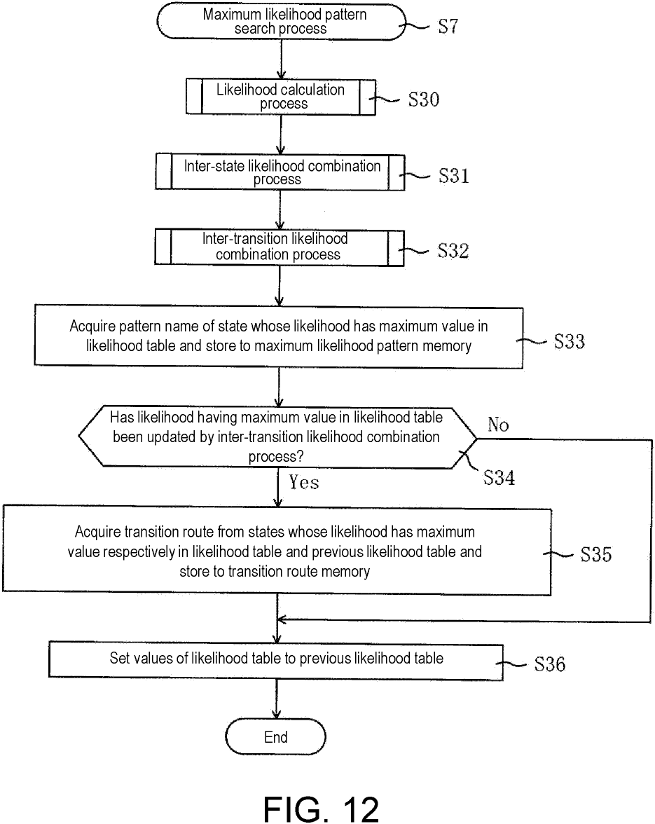

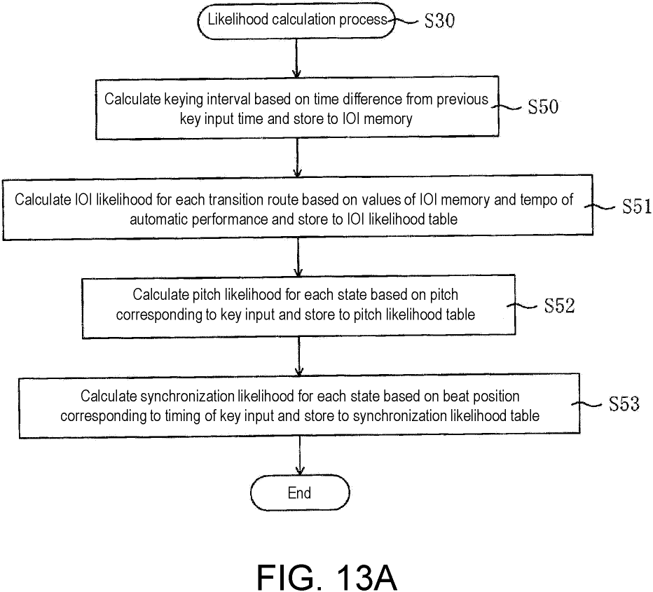

After the process of S6, a maximum likelihood pattern search process is executed (S7). Herein, the maximum likelihood pattern search process will be described with reference to FIG. 12 to FIG. 14.

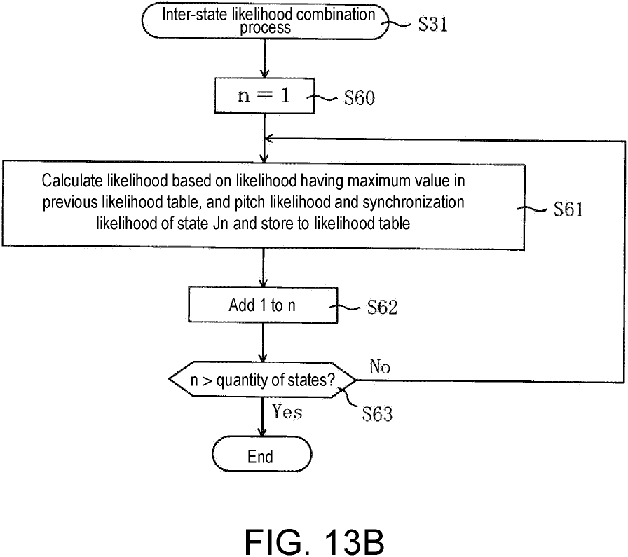

FIG. 12 is a flowchart of the maximum likelihood pattern search process. In the maximum likelihood pattern search process, first, a likelihood calculation process is performed (S30). The likelihood calculation process will be described with reference to FIG. 13A

FIG. 13A is a flowchart of the likelihood calculation process. In the likelihood calculation process, first, a time difference between inputs of performance information from the key 2a, i.e., a keying interval, is calculated based on a difference between the time of a previous input of performance information from the key 2a and the time of a current input of performance information from the key 2a, and the calculated keying interval is stored to the IOI memory 12e (S50).

After the process of S50, an IOI likelihood is calculated based on the keying interval in the IOI memory 12e, the tempo of the automatic performance described above, and a beat distance of each transition route Rm in the inter-transition route likelihood table 11gx of the corresponding music genre, and the calculated IOI likelihood is stored to the IOI likelihood table 12h (S51). Specifically, letting x be the keying interval in the IOI memory 12e, Vm be the tempo of the automatic performance, and Δτ be the beat distance of a transition route Rm stored in the inter-transition route likelihood table 11gx, an IOI likelihood G is calculated according to a Gaussian distribution of Equation (1).

$$G = \frac{1}{\sqrt{2 π {σ}^{2}}} exp \left(- \frac{{\left(\frac{x}{V m} - Δ τ\right)}^{2}}{2 {σ}^{2}}\right)$$

Herein, σ is a constant representing the standard deviation in the Gaussian distribution of Equation (1) and is set to a value calculated in advance through experiments or the like. This IOI likelihood G is calculated for all transition routes Rm and the results are stored to the IOI likelihood table 12h. That is, since the IOI likelihood G follows the Gaussian distribution of Equation (1), a greater value of IOI likelihood G is set for the transition route Rm as the beat distance of the transition route Rm has a smaller difference from the keying interval in the IOI memory 12e.

After the process of S51, a pitch likelihood is calculated for each state Jn based on the pitch of the performance information from the key 2a, and the calculated pitch likelihood is stored to the pitch likelihood table 12f (S52). As described above with reference to FIG. 9A, the pitch of the performance information from the key 2a is compared with the pitch of each state Jn in the state pattern table 11cx of the corresponding music genre, and then “1” is set to the pitch likelihood of each state Jn, whose pitch perfectly matches the pitch of the performance information, in the pitch likelihood table 12f, “0.54” is set to the pitch likelihood of each state Jn, whose pitch partially matches, in the pitch likelihood table 12f, and “0.4” is set to the pitch likelihood of each state Jn, whose pitch does not match, in the pitch likelihood table 12f.

After the process of S52, a synchronization likelihood is calculated based on a beat position corresponding to the time at which the performance information of the key 2a has been inputted and a beat position in the state pattern table 11cx of the corresponding music genre, and the calculated synchronization likelihood is stored to the synchronization likelihood table 12g (S53). Specifically, letting tp be a beat position in a unit of two bars into which the time at which the performance information of the key 2a has been inputted is converted, and τ be the beat position in the state pattern table 11cx of the corresponding music genre, a synchronization likelihood B is calculated according to a Gaussian distribution of Equation (2).

$$B = \frac{1}{\sqrt{2 π {ρ}^{2}}} exp \left(- \frac{{\left(t p - τ\right)}^{2}}{2 {ρ}^{2}}\right)$$

Herein, ρ is a constant representing the standard deviation in the Gaussian distribution of Equation (2) and is set to a value calculated in advance through experiments or the like. This synchronization likelihood B is calculated for all states Jn and the results are stored to the synchronization likelihood table 12g. That is, since the synchronization likelihood B follows the Gaussian distribution of Equation (2), a greater value of synchronization likelihood B is set for the state Jn as the beat position of the state Jn has a smaller difference from the beat position corresponding to the time at which the performance information of the key 2a has been inputted.

After the process of S53, the likelihood calculation process is ended and the process returns to the maximum likelihood pattern search process of FIG. 12.

Referring back to FIG. 12, after the likelihood calculation process of S30, an inter-state likelihood combination process is executed (S31). Herein, the inter-state likelihood combination process will be described with reference to FIG. 13B.

FIG. 13B is a flowchart of the inter-state likelihood combination process. This inter-state likelihood combination process is a process for calculating a likelihood for each state Jn based on each likelihood calculated in the likelihood calculation process in FIG. 13A. In the inter-state likelihood combination process, first, 1 is set to a counter variable n (S60). Hereinafter, “n” in the “state Jn” in the inter-state likelihood combination process represents the counter variable n. For example, when the counter variable n is 1, the state Jn represents the “state J1.”

After the process of S60, the likelihood of the state Jn is calculated based on the maximum value of the likelihood stored in the previous likelihood table 12j, the pitch likelihood of the state Jn in the pitch likelihood table 12f, and the synchronization likelihood of the state Jn in the synchronization likelihood table 12g, and the calculated likelihood is stored to the likelihood table 12i (S61). Specifically, letting Lp_M be the maximum value of the likelihood stored in the previous likelihood table 12j, Pi_n be the pitch likelihood of the state Jn in the pitch likelihood table 12f, and B_n be the synchronization likelihood of the state Jn in the synchronization likelihood table 12g, a logarithmic likelihood log(L_n) which is the logarithm of the likelihood L_n of the state Jn is calculated according to a Viterbi algorithm of Equation (3).

$$log \left(L \_ n\right) = log \left(L p \_ M\right) + log \left(P i \_ n\right) + log \left(α ⋅ B \_ n\right)$$

Herein, α is a penalty constant for the synchronization likelihood Bn, that is, a constant considering the case of not transitioning to the state Jn, and is set to a value calculated in advance through experiments or the like. The likelihood L_n obtained by removing the logarithm from the logarithmic likelihood log(L_n) calculated according to Equation (3) is stored to a memory area corresponding to the state Jn in the likelihood table 12i.

After S61, 1 is added to the counter variable n (S62) and it is confirmed whether the counter variable n after the addition is greater than the quantity of states Jn (S63). If it is determined in the process of S63 that the counter variable n is equal to or less than the quantity of states Jn, the processes from S61 onwards are repeated. On the other hand, if it is determined that the counter variable n is greater than the quantity of states Jn (S63: Yes), the inter-state likelihood combination process is ended and the process returns to the maximum likelihood pattern search process of FIG. 12.

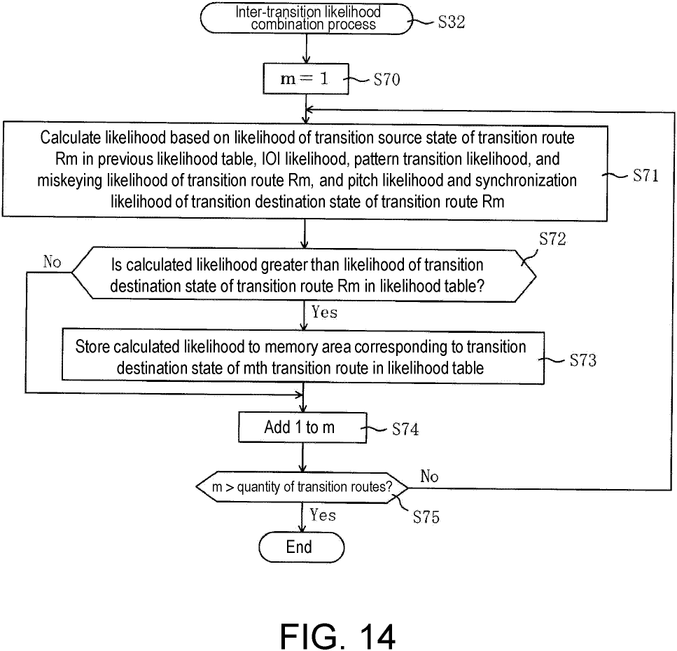

Referring back to FIG. 12, after the inter-state likelihood combination process of S31, an inter-transition likelihood combination process is executed (S32). The inter-transition likelihood combination process will be described below with reference to FIG. 14.

FIG. 14 is a flowchart of the inter-transition likelihood combination process. The inter-transition likelihood combination process is a process for calculating a likelihood of the transition destination state Jn of each transition route Rm based on each likelihood calculated in the likelihood calculation process of FIG. 13A and the pattern transition likelihood and the miskeying likelihood of the preset inter-transition route likelihood table 11d.

In the inter-transition likelihood combination process, first, 1 is set to a counter variable m (S70). Hereinafter, “m” in the “transition route Rm” in the inter-transition likelihood combination process represents the counter variable m. For example, when the counter variable m is 1, the transition route Rm represents the “transition route R1.”

After the process of S70, a likelihood is calculated based on the likelihood of the transition source state Jn of the transition route Rm in the previous likelihood table 12i, the IOI likelihood of the transition route Rm in the IOI likelihood table 12h, the pattern transition likelihood and the miskeying likelihood in the inter-transition route likelihood table 11gx of the corresponding music genre, the pitch likelihood of the transition destination state Jn of the transition route Rm in the pitch likelihood table 12f, and the synchronization likelihood of the transition destination state Jn of the transition route Rm in the synchronization likelihood table 12g (S71).

Specifically, letting Lp_mb be the previous likelihood of the transition source state Jn of the transition route Rm in the previous likelihood table 12j, I_m be the IOI likelihood of the transition route Rm in the IOI likelihood table 12h, Ps_m be the pattern transition likelihood in the inter-transition route likelihood table 11gx of the corresponding music genre, Ms_m be the miskeying likelihood in the inter-transition route likelihood table 11gx of the corresponding music genre, Pi_mf be the pitch likelihood of the transition destination state Jn of the transition route Rm in the pitch likelihood table 12f, and B_mf be the synchronization likelihood of the transition destination state Jn of the transition route Rm in the synchronization likelihood table 12g, a logarithmic likelihood log(L), which is the logarithm of the likelihood L, is calculated according to a Viterbi algorithm of Equation (4).

$$\begin{matrix}log \left(L\right) = log \left(L p \_ m b\right) + log \left(I \_ m\right) + log \left(P s \_ m\right) + log \\ \left(M s \_ m\right) + log \left(P i \_ m f\right) + log \left(B \_ m f\right)\end{matrix}$$

Then, the likelihood L is calculated by removing the logarithm from the logarithmic likelihood log(L) calculated according to the above Equation (4).

After the process of S71, it is confirmed whether the likelihood L calculated in the process of S70 is greater than the likelihood of the transition destination state Jn of the transition route Rm in the likelihood table 12i (S72). If it is determined in the process of S72 that the likelihood L calculated in the process of S70 is greater than the likelihood of the transition destination state Jn of the transition route Rm in the likelihood table 12i, the likelihood L calculated in the process of S70 is stored to a memory area corresponding to the transition destination state Jn of the transition route Rm in the likelihood table 12i (S73).

On the other hand, if it is determined in the process of S72 that the likelihood L calculated in the process of S70 is equal to or less than the likelihood of the transition destination state Jn of the transition route Rm in the likelihood table 12i (S72: No), the process of S73 is skipped.

After the processes of S72 and S73, 1 is added to the counter variable m (S74) and thereafter it is confirmed whether the counter variable m is greater than the quantity of transition routes Rm (S75). If it is determined in the process of S75 that the counter variable m is equal to or less than the quantity of transition routes Rm (S75: No), the processes from S71 onwards are repeated and, if it is determined in the process of S75 that the counter variable m is greater than the quantity of transition routes Rm (S75: Yes), the inter-transition likelihood combination process is ended and the process returns to the maximum likelihood pattern search process of FIG. 12.

Referring back to FIG. 12, after the inter-transition likelihood combination process in S32, a state Jn which takes a likelihood of a maximum value in the likelihood table 12i is acquired, and an input pattern Pi corresponding to this state Jn is acquired from the state pattern table 11cx of the corresponding music genre and stored to the maximum likelihood pattern memory 12c (S33). That is, the most likely state Jn for the performance information from the key 2a is acquired from the likelihood table 12i, and the input pattern Pi corresponding to this state Jn is acquired. Accordingly, it is possible to select (estimate) the most likely input pattern Pi for the performance information from the key 2a.

After the process of S33, it is confirmed whether the likelihood of the maximum value in the likelihood table 12i has been updated by the inter-transition likelihood combination process of S32 (S34). That is, it is confirmed whether the likelihood of the state Jn used for pattern determination in the process of S33 has been updated according to a likelihood based on the previous likelihood Lp_mb by the processes of S71 to S73 in FIG. 14.

If it is determined in the process of S34 that the likelihood of the maximum value in the likelihood table 12i has been updated by the inter-transition likelihood combination process (S34: Yes), based on the state Jn which takes the likelihood of the maximum value in the likelihood table 12i and the state Jn which takes the likelihood of the maximum value in the previous likelihood table 12j, a current transition route Rm is acquired and stored to the transition route memory 12d (S35). Specifically, the state Jn which takes the likelihood of the maximum value in the likelihood table 12i and the state Jn which takes the likelihood of the maximum value in the previous likelihood table 12j are searched by the transition destination state Jn and the transition source state Jn of the inter-transition route likelihood table 11gx of the corresponding music genre, a transition route Rm in which these states Jn match is acquired from the inter-transition route likelihood table 11gx of the corresponding music genre and stored to the transition route memory 12d.

If it is determined in the process of S34 that the likelihood of the maximum value in the likelihood table 12i has not been updated by the inter-transition likelihood combination process (S34: No), the process of S35 is skipped.

After the processes of S34 and S35, the values of the likelihood table 12i are set to the previous likelihood table 12j (S36), and after the process of S36, the maximum likelihood pattern search process is ended, and the process returns to the main process of FIG. 11.

Referring back to FIG. 11, after the maximum likelihood pattern search process of S7, the operation mode selected by the performer via the setting button 3 is confirmed (S8). If it is determined in the process of S8 that the operation mode is the mode 1 (S8: “mode 1”), a probability corresponding to the input pattern Pi in the maximum likelihood pattern memory 12c is acquired from the sound generation probability comparison table 11e, and the acquired probability is applied to the sound generation probability pattern Pb in the sound generation probability pattern memory 12b (S9). Specifically, in the sound generation probability pattern memory 12b of the case where the operation mode is the mode 1, since beat positions set with “*” are present, the probability acquired from the sound generation probability comparison table 11e is set to the beat positions at which “*” is set.

On the other hand, if it is determined in the process of S8 that the operation mode is the mode 2 (S8: “mode 2”), a sound generation probability pattern Pb corresponding to the input pattern Pi in the maximum likelihood pattern memory 12c is acquired from the fixed sound generation probability table 11f and stored to the sound generation probability pattern Pb (S10).

After the processes of S9 and S10, based on the sound generation probability pattern Pb of the sound generation probability pattern memory 12b, it is determined whether to generate sound or not at the current beat position of the automatic performance (S11). Specifically, the probability of the current beat position of the automatic performance is acquired from the sound generation probability pattern Pb of the sound generation probability pattern memory 12b. Whether to generate sound or not is determined based on this probability. At this time, in the case where the current beat position of the performance pattern Pa in the performance pattern memory 12a is a chord, as described above, whether to generate sound or not is determined for each note composing the chord.

Although a conventional method for determining whether to generate sound or not based on the probability has been adopted, for example, in the case where an integer pseudo-random number is generated in the range of 1 to 100 and the probability is 40%, for example, when the generated pseudo-random number is 1 to 40, it may be determined “to generate sound”, and when the generated pseudo-random number is 41 to 100, it may be determined “not to generate sound”.

After the process of S11, a musical sound based on the performance information of the key 2a and a musical sound of the note at the current beat position of the performance pattern Pa in the performance pattern memory 12a corresponding to “to generate sound”/“not to generate sound” at the current beat position determined in the process of S11 are outputted (S12), and the processes from S6 onwards are repeated.

Although the disclosure has been described based on the above embodiment, it can be easily inferred that various improvements and modifications are possible.

In the above embodiment, the synthesizer 1 is illustrated as an automatic performance apparatus. However, the disclosure is not necessarily limited thereto and may be applied to an electronic musical instrument that outputs an automatic performance together with a musical sound generated by the performer’s performance, such as an electronic organ, an electronic piano, and a sequencer.

In the above embodiment, the sound generation probability pattern Pb stored in the variable sound generation probability table 11d or the fixed sound generation probability table 11f is acquired, but the disclosure is not limited thereto. For example, the performer may create a sound generation probability pattern Pb via the setting buttons 3 or the like, and the created sound generation probability pattern Pb may be used for automatic performance. Accordingly, it is possible to realize an automatic performance based on a sound generation probability pattern Pb considering the performer’s intentions and tastes.

In the above embodiment, in the case where the operation mode is the mode 1, the probability corresponding to the maximum-likelihood-estimated input pattern Pi is set to the beat positions of “*” in the sound generation probability pattern Pb. However, the disclosure is not limited thereto, and for example, a probability acquired from the performer via the setting button 3 may be set to the beat positions set with “*” in the sound generation probability pattern Pb.

Alternatively, after setting the probability corresponding to the maximum-likelihood-estimated input pattern Pi to the beat positions of “*” in the sound generation probability pattern Pb, by adding a probability acquired from the performer via the setting button 3 to the probability set at the beat positions of “*”, the probability at the beat positions of “*” may be adjusted by the setting button 3.

In the above embodiment, in the case where the operation mode is the mode 2, the sound generation probability pattern Pb corresponding to the maximum-likelihood-estimated input pattern Pi is acquired from the fixed sound generation probability table 11f, but the disclosure is not limited thereto. For example, a sound generation probability pattern Pb designated by the performer via the setting button 3 may be acquired from the fixed sound generation probability table 11f.

In the above embodiment, the input pattern Pi is maximum-likelihood-estimated based on the inputted performance information, and a probability and a sound generation probability pattern Pb corresponding to the maximum-likelihood-estimated input pattern Pi are acquired, but the disclosure is not limited thereto. Other properties and features of the inputted performance information may also be subjected to maximum likelihood estimation, and the results of such maximum likelihood estimation may be used to acquire the probability and the sound generation probability pattern. For example, based on the inputted performance information, maximum likelihood estimation may be performed on the tempo and melody of the tune performed by the performer, the music genre (rock, pop, etc.) of the tune performed, etc., and the probability and the sound generation probability pattern Pb corresponding to the maximum-likelihood-estimated tempo or the like may be acquired. In this case, a probability corresponding to each maximum-likelihood-estimated tempo or the like may be set in the sound generation probability comparison table 11e (see FIG. 7B), and a sound generation probability pattern Pb corresponding to each maximum-likelihood-estimated tempo or the like may be set in the fixed sound generation probability table 11f (see FIG. 7C).

In the above embodiment, according to the probability of the sound generation probability pattern Pb in the sound generation probability pattern memory 12b, whether to generate sound or not is determined at each beat position of the performance pattern in the performance pattern memory 12a. However, the disclosure is not limited thereto, and, for example, according to the probability of the sound generation probability pattern Pb in the sound generation probability pattern memory 12b, a volume (velocity) at each beat position of the performance pattern in the performance pattern memory 12a may be determined.

For example, in the case where the probability of a beat position in the sound generation probability pattern Pb of the sound generation probability pattern memory 12b is “60%”, the volume of a beat position of the performance pattern in the performance pattern memory 12a corresponding to this beat position may be set to a volume corresponding to 60% of the maximum volume being 100%, and a musical sound of the note at the beat position may be outputted. In addition, a length of the sound to be generated, a stereo position (Pan), timbre parameters (filter, envelope, etc.), a degree of sound effects, etc. may also be changed according to the probability of the sound generation probability pattern Pb.

In the above embodiment, notes are set in chronological order as a performance pattern Pa used for automatic performance, but the disclosure is not limited thereto. For example, a rhythm pattern such as a drum pattern or a bass pattern, or sound data such as a human singing voice may also be used as a performance pattern Pa used for automatic performance.

In the above embodiment, the performance duration of the input pattern Pi has a length of two bars in common time. However, the disclosure is not limited thereto and the performance duration of the input pattern Pi may be one bar or may be three or more bars. Also, the meter of the input pattern Pi is not limited to common time, and another meter such as three-four time or six-eight time may also be used as appropriate.

The above embodiment is configured such that performance information is inputted through the keyboard 2. However, alternatively, the disclosure may be configured such that a keyboard of an external MIDI standard is connected to the synthesizer 1 and performance information is inputted through such a keyboard. Alternatively, the disclosure may be configured such that an external MIDI device such as a sequencer, an electronic musical instrument such as another synthesizer, or a PC executing music production software such as a DAW is connected to the synthesizer 1 to input performance information. Furthermore, the disclosure may also be configured such that performance information is inputted from MIDI data stored in the flash ROM 11 or the RAM 12.

The above embodiment is configured such that a musical sound is outputted through the sound source 13, the DSP 14, the DAC 16, the amplifier 17, and the speaker 18 provided in the synthesizer 1. However, alternatively, the disclosure may be configured such that a sound source device of the MIDI standard is connected to the synthesizer 1 and a musical sound of the synthesizer 1 is outputted through the sound source device.

The above embodiment is configured such that the control program 11a is stored in the flash ROM 11 of the synthesizer 1 and operates on the synthesizer 1. However, the disclosure is not limited thereto and may be configured such that the control program 11a is caused to operate on another computer such as a personal computer (PC), a mobile phone, a smartphone, or a tablet terminal. In this case, the disclosure may be configured such that performance information is inputted through a keyboard of the MIDI standard or a character input keyboard connected to the PC or the like in a wired or wireless manner, in place of the keyboard 2 of the synthesizer 1, or may be configured such that performance information is inputted through a software keyboard displayed on a display device of a PC or the like.

The numerical values stated in the above embodiments are merely examples and other numerical values may of course be adopted.

What is claimed is:

1. An automatic performance apparatus which automatically performs a performance pattern in which sound generation timings of notes to be sounded are set, the automatic performance apparatus comprising:
a sound generation probability pattern acquisition part which acquires a sound generation probability pattern in which a probability of sounding a note is set for each sound generation timing of the performance pattern; and
an automatic performance part which performs an automatic performance by determining whether to sound the note for each sound generation timing of the performance pattern based on the probability of each sound generation timing set in the sound generation probability pattern acquired by the sound generation probability pattern acquisition part.

2. The automatic performance apparatus according to claim 1, wherein
in a case where a predetermined sound generation timing in the performance pattern is composed of a chord of a plurality of notes, the automatic performance part performs an automatic performance according to the performance pattern by determining whether to generate sound for each note composing the chord based on the probability of the sound generation timing set in the sound generation probability pattern acquired by the sound generation probability pattern acquisition part.

3. The automatic performance apparatus according to claim 1, comprising:
an input part which inputs performance information; and
a probability acquisition part which acquires a maximum-likelihood-estimated probability based on the performance information inputted to the input part, wherein
the sound generation probability pattern acquisition part acquires a sound generation probability pattern in which the probability acquired by the probability acquisition part is set as the probability of sounding the note at each sound generation timing of the performance pattern.

4. The automatic performance apparatus according to claim 3, comprising:
an input pattern storage part which stores a plurality of input patterns; and
an input pattern selection part which selects a maximum-likelihood-estimated input pattern from among the plurality of input patterns stored in the input pattern storage part based on the performance information inputted by the input part, wherein
the probability acquisition part acquires a probability corresponding to the input pattern selected by the input pattern selection part.

5. The automatic performance apparatus according to claim 4, wherein
the probability acquisition part acquires a probability having a value that is greater as a sound generation timing between notes of the input pattern selected by the input pattern selection part is shorter.

6. The automatic performance apparatus according to claim 1, comprising:
a sound generation probability pattern storage part which stores a plurality of the sound generation probability patterns; and
an input part which inputs performance information, wherein
the sound generation probability pattern acquisition part acquires a maximum-likelihood-estimated sound generation probability pattern based on the performance information inputted to the input part from among the sound generation probability patterns stored in the sound generation probability pattern storage part.

7. The automatic performance apparatus according to claim 6, comprising:
an input pattern storage part which stores a plurality of input patterns; and
an input pattern selection part which selects a maximum-likelihood-estimated input pattern from among the plurality of input patterns stored in the input pattern storage part based on the performance information inputted to the input part, wherein
the sound generation probability pattern acquisition part acquires a sound generation probability pattern corresponding to the input pattern selected by the input pattern selection part from among the sound generation probability patterns stored in the sound generation probability pattern storage part.

8. The automatic performance apparatus according to claim 4, comprising:
a likelihood calculation part which calculates a likelihood for each of all or part of notes composing a plurality of input patterns stored in the input pattern storage part based on the performance information inputted to the input part, wherein
the input pattern selection part maximum-likelihood-estimates one input pattern among the plurality of input patterns stored in the input pattern storage part based on the likelihood calculated by the likelihood calculation part.

9. The automatic performance apparatus according to claim 8, wherein
the likelihood calculation part calculates a likelihood for each of all or part of notes composing a plurality of input patterns stored in the input pattern storage part based on a pitch of the performance information inputted to the input part.

10. The automatic performance apparatus according to claim 8, wherein
the likelihood calculation part calculates a likelihood for each of all or part of notes composing a plurality of input patterns stored in the input pattern storage part based on a beat position of the performance information inputted to the input part.

11. The automatic performance apparatus according to claim 8, wherein
the likelihood calculation part calculates a likelihood of sounding another note next to one note, for each of all or part of notes composing a plurality of input patterns stored in the input pattern storage part based on an input interval between previous performance information and current performance information inputted to the input part.

12. The automatic performance apparatus according to claim 4, wherein
the input pattern selection part executes a selection process of the input pattern when performance information is inputted to the input part.

13. The automatic performance apparatus according to claim 2, comprising:
an input part which inputs performance information; and
a probability acquisition part which acquires a maximum-likelihood-estimated probability based on the performance information inputted to the input part, wherein
the sound generation probability pattern acquisition part acquires a sound generation probability pattern in which the probability acquired by the probability acquisition part is set as the probability of sounding the note at each sound generation timing of the performance pattern.

14. The automatic performance apparatus according to claim 13, comprising:
an input pattern storage part which stores a plurality of input patterns; and
an input pattern selection part which selects a maximum-likelihood-estimated input pattern from among the plurality of input patterns stored in the input pattern storage part based on the performance information inputted by the input part, wherein
the probability acquisition part acquires a probability corresponding to the input pattern selected by the input pattern selection part.

15. The automatic performance apparatus according to claim 14, wherein
the probability acquisition part acquires a probability having a value that is greater as a sound generation timing between notes of the input pattern selected by the input pattern selection part is shorter.

16. The automatic performance apparatus according to claim 2, comprising:
a sound generation probability pattern storage part which stores a plurality of the sound generation probability patterns; and
an input part which inputs performance information, wherein
the sound generation probability pattern acquisition part acquires a maximum-likelihood-estimated sound generation probability pattern based on the performance information inputted to the input part from among the sound generation probability patterns stored in the sound generation probability pattern storage part.

17. The automatic performance apparatus according to claim 16, comprising:
an input pattern storage part which stores a plurality of input patterns; and
an input pattern selection part which selects a maximum-likelihood-estimated input pattern from among the plurality of input patterns stored in the input pattern storage part based on the performance information inputted to the input part, wherein
the sound generation probability pattern acquisition part acquires a sound generation probability pattern corresponding to the input pattern selected by the input pattern selection part from among the sound generation probability patterns stored in the sound generation probability pattern storage part.

18. The automatic performance apparatus according to claim 1, wherein the sound generation probability pattern acquisition part acquires a sound generation probability pattern created by a user.

19. An automatic performance method comprising:
a sound generation probability pattern acquisition step of acquiring a sound generation probability pattern in which a probability of sounding a note is set for each sound generation timing of a performance pattern in which sound generation timings of notes to be sounded are set; and
an automatic performance step of performing an automatic performance by determining whether to sound the note for each sound generation timing of the performance pattern based on the probability of each sound generation timing set in the sound generation probability pattern acquired in the sound generation probability pattern acquisition step.

20. A non-transitory computer readable medium storing an automatic performance program causing a computer to perform an automatic performance, the automatic performance program causing the computer to execute:
a sound generation probability pattern acquisition step of acquiring a sound generation probability pattern in which a probability of sounding a note is set for each sound generation timing of a performance pattern in which sound generation timings of notes to be sounded are set; and
an automatic performance step of performing an automatic performance by determining whether to sound the note for each sound generation timing of the performance pattern based on the probability of each sound generation timing set in the sound generation probability pattern acquired in the sound generation probability pattern acquisition step.
